(19) United States
(12) Patent Application Publication
(10) Pub. No.: US 2014/0366565 A1
(43) Pub. Date: Dec. 18, 2014

(54) REFRIGERATION ARRANGEMENT FOR TRANSPORTATION VEHICLE CABINS

(71) Applicant: COL-VEN S.A., Guadalupe Norte (AR)

(72) Inventors: Rafael Antonio Colussi, Guadalupe Norte (AR); Nestor Juan Vénica, Guadalupe Norte (AR)

(21) Appl. No.: 14/304,489

(22) Filed: Jun. 13, 2014

(30) Foreign Application Priority Data
Jun. 14, 2013 (ES) 201330886

(51) Int. Cl. B60H 1/32; F25B 15/00

(52) U.S. Cl. CPC B60H 1/3201; F25B 15/00; B60H 2001/3288
USPC 62/238.3; 62/476

(57) ABSTRACT

A refrigeration arrangement for transportation vehicle cabins, of the type comprising an ammonia absorption cycle which includes a heat source, a rectifier section, a condenser section, an evaporator section, an absorber section, and from which the solution passes on into an accumulator and later returns to the heat source, using a fluid as a “carrier” for the heat which is generated or absorbed by the solution undergoing the cycle in a closed circuit, allowing for an optimal recovery efficiency of the heat generated between parts of the refrigeration process to improve the refrigeration of rooms, by means of said arrangement of a closed cooling fluid circuit and a refrigeration circuit which are independent from vehicle operation.

### CROSS-REFERENCE TO RELATED APPLICATION

The present application claims priority to Spanish Application No. 201330886, filed one Jun. 14, 2013, said application is hereby incorporated by reference in its entirety.

### FIELD

The present invention relates to the field of devices, equipment and arrangements used for refrigerating rooms and vehicle cabins, and more particularly, it is directed to a refrigerating arrangement for transportation vehicle cabins by ammonia absorption cycles using a non-conventional heat carrier for arrangements of this type, such as, water, which allows for an optimal application of the heat released in the different steps of the refrigeration process.

### BACKGROUND

For a better understanding of the object and scope of the present invention it would be appropriate to describe the current state of the art with reference to the types of air-conditioning equipments currently used in the climatization of medium and large vehicle cabins, and the disadvantages that may arise therefrom.

Refrigeration systems using ammonia-water absorption cycles are well known in the art, and include an assembly comprising a siphon type generator or heater, a rectifier, a condenser, an evaporator, an absorber, and an accumulator among many other components. But the arrangement of these pieces of equipment may vary depending on the vehicle type or model. Usually, it includes fans, together with an evaporator and absorber, which refrigerate the cabin by forced air convection, removing the heat generated in the absorber in the same way.

Nowadays there are various arrangements employing absorption cycles for refrigerating vehicles of different sizes and in different arrangements. For example, U.S. Pat. No. 3,661,200 (McNamara, T. J. 1969) discloses the use of an NH3-H2O absorption cycle, using exhaust heat as a generator for heating the solution at the start of the cycle, and working with helium to create a high pressure atmosphere in the evaporator. Here, a refrigerant solution containing ethylene glycol, which may be connected to the engine's cooling system, is used for cooling the cabin.

EP 0350764 (Spiller, P. 1989) discloses the use of an absorption cycle with two parallel reactors alternatively working as an evaporator and an absorber, within which the absorption and desorption of a component in a non-specified solution take place. For cooling the cabin, a fluid circulating through the radiator is used, while the heat from exhaust gases and forced convection by air coolers is used for heating the solution,.

Furthermore, U.S. Pat. No. 5,896,747 (Antohi, V. 1996), discloses the use of a process similar to the above, but using lithium bromide solution in water, and feeding the generator with hot water exiting from the vehicle engine.

U.S. Pat. No. 4,253,310 (Sokolov, M. 1978), discloses the use of a process similar to the above, but differing in the use of the refrigerant, which in this case is engine refrigerant, and also differing in the refrigeration of the absorber section, as heat is not recycled but instead it is forced into the environment by forced convection.

Patent document U.S. Pat. No. 5,231,849 (Rosenblatt J. H. 1992), discloses the use of a process similar to the above, but differing in the use of exhaust gases as a heat source for the generator, such process then depending on whether the vehicle is on or off.

Although the use of fans for forced convection in air-conditioning equipments is a widely used method which is well known in the art, the system is subject to heat losses which might otherwise be reused in other parts of the process. Furthermore, when the purpose is to refrigerate vehicle cabins, the fact that said refrigeration equipment depends exclusively on the vehicle engine operation is a limiting factor which may greatly affect the operation of refrigeration equipment in case of engine failure or exhaust system failure.

In view of the currently available state of the art for refrigerating vehicle cabins, a new refrigeration arrangement for removing heat/cold from equipment, improving efficiency, reducing heat losses and obtaining an apparatus which is independent from vehicle operation that could be used even when the vehicle is turned off would be highly desirable.

### SUMMARY OF THE INVENTION

Accordingly, it is an object of the present invention to provide a new refrigeration arrangement for transportation vehicle cabins, using water as “carrier” for the heat which is generated or absorbed by the solution undergoing the cycle, for example NH3-H2O, in a closed circuit.

It is another object of the present invention to provide an alternative heat source for said refrigeration arrangement, which is independent from vehicle engine operation in order to enable operation of said arrangement without the need of starting up the vehicle.

It is even another object of the present invention to provide an alternative to the known ammonia-water absorption cycle, employing a bubble pump in parallel with the main generator of the arrangement, thus achieving a higher efficiency in the recovery of heat released by the cycle.

It is even another object of the present invention to provide multiple different embodiments for the secondary water circuit arrangement which removes heat from the process.

It is also a further object of the present invention to provide a refrigeration arrangement for transportation vehicle cabins, of the type comprising an ammonia absorption cycle which includes a heat source for starting the cycle, wherein an ammonia-water solution is evaporated, is circulated along a circuit comprising a rectifier section where the ammonia vapor is evaporated, a condenser section where ammonia is condensed as pure liquid ammonia, an evaporator section where ammonia is heated under pressure to absorb heat from outside and an absorber section where ammonia is reabsorbed into a less concentrated ammonia-water solution and from which the solution passes on to an accumulator and later returns to the heat source, wherein said arrangement comprises closed cooling fluid circuit having at least three heat exchangers namely, a first exchanger arranged in thermal exchange relationship with said absorber section, a second exchanger arranged in thermal exchange relationship with said condenser section and a third exchanger arranged in thermal exchange relationship with said rectifier section, a refrigeration circuit comprising at least one temperature exchanger having a cabin section and an evaporator section, wherein said heat source comprises a heater which is independent from the vehicle engine and powered by fuel.

### BRIEF DESCRIPTION OF THE DRAWINGS

For further clarity and understanding of the object of the present invention, it is illustrated in several figures, wherein:

FIG. 1 shows a schematic view of the pieces of equipment comprising the conventional ammonia-water absorption cycle according to the prior art;

FIG. 2 shows a schematic view of a first preferred embodiment of the closed cooling fluid circuit according to the object of the present invention;

FIG. 3 shows a schematic view of a second preferred embodiment of the closed cooling fluid circuit according to the invention;

FIG. 4 shows a schematic view of a third preferred embodiment of the closed cooling fluid circuit according to the invention;

FIG. 5 shows a schematic view of a fourth preferred embodiment of the closed cooling fluid circuit according to the invention;

FIG. 6 is a view of the internal structure of the generator, according to the invention;

FIG. 7 is a scheme of the heating unit feeding the generator, according to the invention.

### DETAILED DESCRIPTION

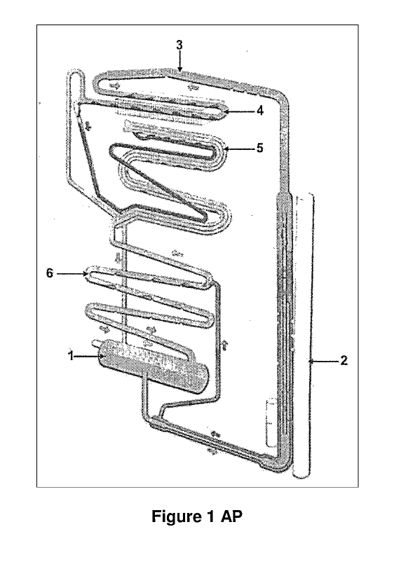

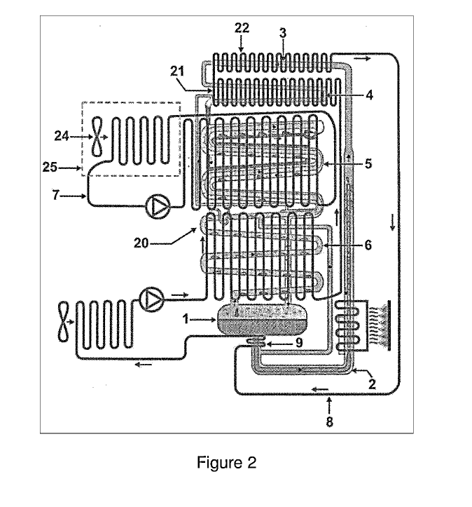

Making reference to the figures, it is shown that the invention consists of a series of arrangements for using a closed cooling fluid circuit as a refrigeration arrangement for an ammonia absorption cycle in water. The object of the preferred embodiments of closed circuits is to provide alternatives for placing parts of equipment of said cycle in an arrangement located away from the cabin, if desired, then “transporting” the desired temperature along said circuits. In the present Description It is emphasized that those parts defining the same component have the same reference numbers in FIG. 1 related to the prior art as well as in FIGS. 2 to 7 referred to the present invention.

Making reference now to FIG. 1 according to the prior art, an arrangement of pieces of equipment is shown, which are part of a conventional absorption cycle, comprising a generator 2 for starting the cycle, where an ammonia-rich solution is evaporated, thereby causing the separation of a high-pressure ammonia gas from an ammonia-poor solution. Said high-pres sure ammonia gas is then circulated into a rectifier section 3, where it is stripped from the remaining water that may have been entrained by the ammonia gas. Once the high pressure ammonia gas has been purified, it proceeds into a condenser section 4, where it releases heat into the environment, under certain temperature and pressure conditions, and changes back its state from gas into liquid again. Next, said liquid ammonia flows into an evaporator section 5, where it is evaporated under a high pressure inert gas atmosphere, thus removing heat from the environment. As drops of liquid ammonia descend along the tilted tubes of the evaporator, they are converted back into a gas, which descends along the tubes up to the absorber section 6, where it is contacted with the poor ammonia solution from generator 2. This contact allows for reabsorbing ammonia into the solution, which then falls into an accumulator 1, as an ammonia rich solution. Said accumulator 1 acts like a storage container for the solution, which is then returned to generator 2, thus restart the cycle.

According to an object of the present invention, as may be observed in FIG. 2, one of the preferred alternative embodiments provided by the invention for refrigerating said absorption cycle, consists in a closed cooling fluid circuit 8 having at least three heat exchangers, namely, a first exchanger 20 arranged in thermal exchange relationship with said absorber section 6, where said cooling fluid removes heat from the absorption cycle, a second exchanger 21 arranged in thermal exchange relationship with said condenser section 4, where said cooling fluid removes heat from the absorption cycle, and a third exchanger 22 arranged in thermal exchange relationship with said rectifier section 3, being all three such heat exchangers arranged in series.

Upstream the cooling section of said first closed circuit 8, which takes place between the absorber 6 section and rectifier 3 section, there is a preheating section 9 for the ammonia-rich solution, located at the exit of accumulator 1, before it enters into generator 2, where said cooling fluid transfers heat to the absorption cycle. Said first closed circuit 8 is cooled between the absorber section 6 and the preheating section 9 by means of forced air convection. As may be seen in FIG. 2, the arrangement comprises a second closed cooling fluid circuit 7 comprising at least one temperature exchanger comprising a cabin section 24 and an evaporator section 5. In cabin section 24, cooling of vehicle cabin 25 is carried out by forced convection.

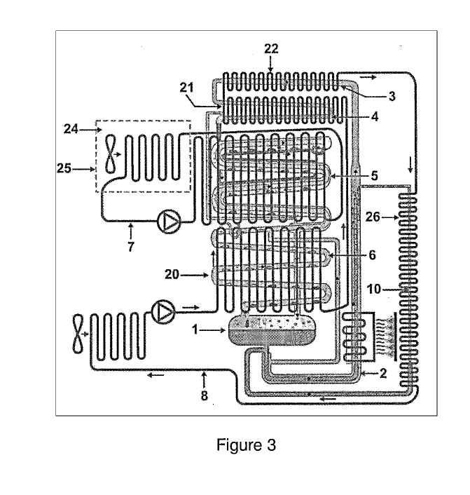

With reference to FIG. 3, another preferred alternative embodiment provided by the invention for refrigerating said absorption cycle using a fluid as “carrier” of the heat generated or absorbed by the solution undergoing the cycle in a closed circuit, which allows for an optimal recovery efficiency of the heat generated between parts of the refrigeration process, consists in a closed cooling fluid circuit 8 having at least four heat exchangers, namely, a first exchanger 20 arranged in thermal exchange relationship with said absorber section 6, where said cooling fluid removes heat from the absorption cycle, a second exchanger 21 arranged in thermal exchange relationship with said condenser section 4, where said cooling fluid removes heat from the absorption cycle, a third exchanger 22 arranged in thermal exchange relationship with said rectifier section 3, and a fourth exchanger 26 arranged in exchange relationship with a bubble pump section 10 arranged in parallel to generator section 2 of the cycle, where said cooling fluid transfers heat to the ammonia-water solution, the four heat exchangers being arranged in series.

Further, said first closed circuit 8 is cooled between the absorber section 6 and the bubble pump section 10 by means of forced air convection. As may be seen in FIG. 3, and according to the invention, the arrangement comprises a second closed cooling fluid circuit 7 comprising at least one temperature exchanger comprising a cabin section 24 and an evaporator section 5. In cabin section 24, cooling of vehicle cabin 25 is carried out by forced convection.

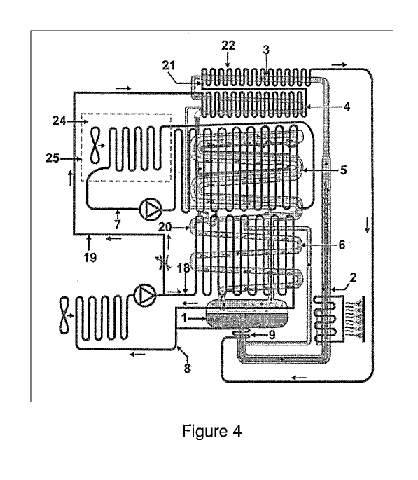

According to FIG. 4, even another alternative preferred embodiment provided by the invention for refrigerating said absorption cycle, consists in a closed cooling fluid circuit 8 having at least three heat exchangers, namely, in a first branch 18 a first exchanger 20 is arranged in thermal exchange relationship with said absorber section 6, wherein said cooling fluid removes heat from the absorption cycle, wherein said first branch 18 is arranged in parallel with a second branch 19 having a second exchanger 21 arranged in thermal exchange relationship with said condenser section 4, where said cooling fluid removes heat from the absorption cycle, and a third exchanger 22 arranged in thermal exchange relationship with said rectifier section 3, wherein said second and third exchangers are arranged in series.

Also, part of branch 19 has a preheating section 9 of an ammonia-rich solution following the exit of accumulator section 1 and before entering generator 2, where said cooling fluid transfers heat to the absorption cycle. In turn, said first closed circuit 8 is cooled between a linking section of branches 18 and 19 and the separation section of branches 18 and 19 by means of forced air convection. As may be seen in FIG. 4, and according to the invention, the arrangement includes a second closed cooling fluid circuit 7 comprising at least one temperature exchanger with a cabin section 24 and an evaporator section 5. In cabin section 24, cooling of vehicle cabin 25 is carried out by forced convection.

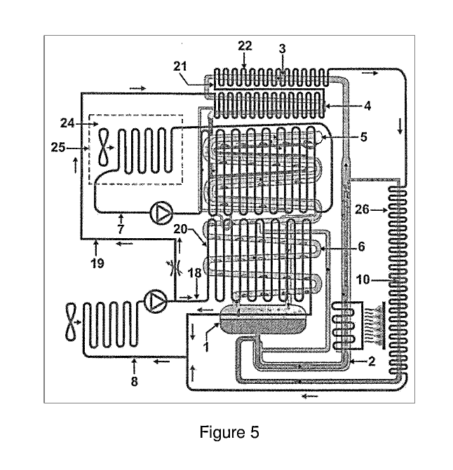

According to FIG. 5, even another alternative preferred embodiment provided by the invention for refrigerating said absorption cycle, consists in a closed cooling fluid circuit 8 having at least four heat exchangers, in a first branch 18 a first exchanger 20 is arranged in thermal exchange relationship with said absorber section 6, wherein said cooling fluid removes heat from the absorption cycle, arranged in parallel with a second branch 19 having a second exchanger 21 arranged in thermal exchange relationship with said condenser section 4, where said cooling fluid removes heat from the absorption cycle, and a third exchanger 22 arranged in thermal exchange relationship with said rectifier section 3 and a fourth exchanger 26 arranged in thermal exchange relationship with a bubble pump section 10 arranged in parallel to generator section 2 of the cycle, where said cooling fluid transfers heat to the ammonia-water solution, wherein the last three exchangers are arranged in series.

Said first closed circuit 8 is cooled between a linking section of branches 18 and 19 and the separation section of branches 18 and 19 by means of forced air convection. As may be seen in FIG. 5, and according to the invention, the arrangement includes a second closed cooling fluid circuit 7 comprising at least one temperature exchanger with a cabin section 24 and an evaporator section 5. In cabin section 24, cooling of vehicle cabin 25 is carried out by forced convection.

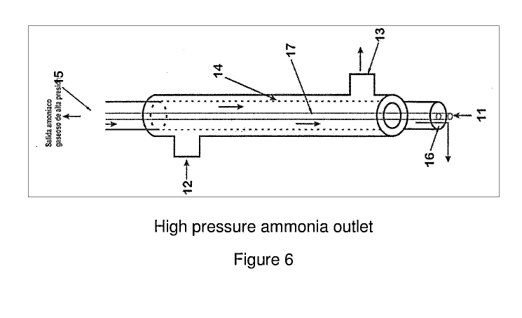

In all of the above-mentioned cases, according to the invention, generator 2 is fed with a cooling fluid from a heating unit. As shown in FIG. 6, said cooling fluid circulates through an annular space 14 comprised between two concentric tubes, wherein an ammonia-rich solution rises upward from the accumulator 1 along a central concentric tube 17, where such ammonia-rich solution splits into two phases when heated by the cooling fluid. A first phase consists in high pressure ammonia gas, which rises through the concentric tube, exits through a high pressure ammonia gas outlet 15 and proceeds to the rectifier section 3. Whereas the second phase consists in an ammonia-poor liquid solution descending along the exterior of said central concentric tube 17, exiting by an ammonia-poor solution outlet 16 and proceeding into the absorber section 6.

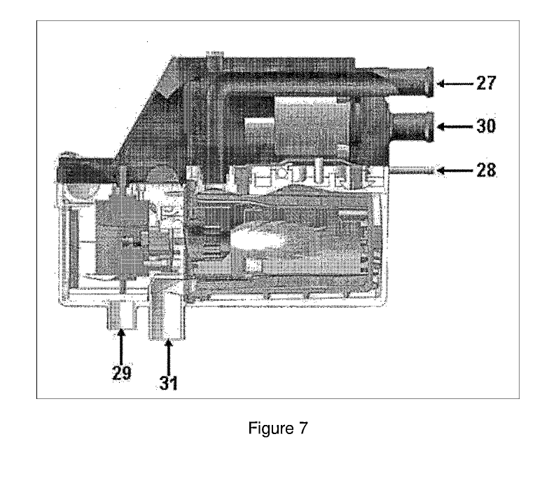

A cooling fluid inlet 12 at the annular space 14 is connected to a cooling fluid outlet 27 of the heating unit. According to FIG. 7, the heating unit operates by burning fuel fed through a fuel inlet 28 from the vehicle storage tank. Said fuel enters into a combustion chamber, together with air entering through a combustion air inlet 29. A cooling fluid inlet 30 is connected with a cooling fluid outlet 13 at the annular space 14 of FIG. 6. The product of said combustion is released through the exhaust gas outlet 31 of FIG. 7, which is then forced out through the vehicle exhaust outlet.

In all of the above-mentioned cases, the tubes used in the evaporator section and in the absorber section on ammonia solution side have an internal spiral structure, which allows for increasing the residence time of the liquid and thereby increases the contact time between the liquid and gas, thus favoring phase exchange.

Thus, the main difference between these conventional systems of the prior art and the present invention is the use of a closed water circuit as secondary refrigerant, or “carrier” of cold/heat removed from the absorption cycle, and the introduction of a bubble pump as secondary heater that reduces heat losses generated by other arrangements with cooling systems by forced air convection, among many other advantages.

What is claimed is:

1. A refrigeration arrangement for transportation vehicle cabins, of the type comprising an ammonia absorption cycle which includes a heat source for starting the cycle where a refrigerant-absorbent solution, for example of ammonia-water circulating through a circuit is heated, said circuit comprising a rectifier section where ammonia vapor is purified, a condenser section for condensing ammonia into liquid state, an evaporator section where ammonia is heated under pressure to absorb heat from outside and an absorber section where ammonia is reabsorbed into a less concentrated solution of ammonia-water and from which the solution passes on into an accumulator and later returns to the heat source, characterized by comprising:
a closed cooling fluid circuit having at least three heat exchangers, namely, a first exchanger arranged in thermal exchange relationship with said absorber section, a second exchanger arranged in thermal exchange relationship with said condenser section and a third exchanger arranged in thermal exchange relationship with said rectifier section,
a refrigeration circuit comprising at least one temperature exchanger comprising a cabin section and an evaporator section,
wherein said heat source comprises a heater which is independent from the vehicle engine and powered by fuel.

2. An arrangement according to claim 1, characterized in that said cooling fluid is water;

3. An arrangement according to claim 1, characterized in that said closed cooling fluid circuit is a series circuit.

4. An arrangement according to claim 3, characterized in that said closed cooling fluid circuit includes a pre-heater between an exit from the accumulator and the heat source.

5. An arrangement according to claim 1, characterized in that said closed cooling fluid circuit is a parallel circuit having a first part which includes said first exchanger, and a second part which includes said second and third exchanger in series.

6. An arrangement according to claim 1, characterized in that a bubble pump is included between said rectifier section and said absorber section.

7. An arrangement according to claim 6, characterized in that said bubble pump is arranged in parallel with said heat source.

8. An arrangement according to claim 1, characterized in that said refrigeration circuit includes water.

9. An arrangement according to claim 1, characterized in that the refrigerant-absorbent solution is water-lithium bromide.
